(19) United States
(12) Patent Application Publication
(10) Pub. No.: US 2026/0266781 A1
(43) Pub. Date: Sep. 10, 2026

(54) ANALYTICAL INSTRUMENT HEALTH CHECK

(71) Applicants: Thermo Fisher Scientific (Bremen) GmbH, Bremen (DE); Thermo Fisher Scientific Brno s. r. o., Brno (CZ)

(72) Inventors: Ralf Günter Hartmer, Hamburg (DE); Petr Chrást, Brno (CZ); Frederik Busse, Bremen (DE); Michal Lacko, Zvolen (SK); Alexander Makarov, Bremen (DE)

(21) Appl. No.: 19/554,850

(22) Filed: Mar. 3, 2026

(30) Foreign Application Priority Data
Mar. 7, 2025 (GB) 2503313.5

(51) Int. Cl. G01N 30/86; G01N 30/02; G01N 30/06; G01N 30/62; G01N 30/72

(52) U.S. Cl. CPC G01N 30/8665; G01N 30/06; G01N 30/7266; G01N 2030/027; G01N 2030/626

(57) ABSTRACT

An analytical instrument comprises an analyser and an atmospheric pressure ion source configured to generate analyte ions in an ionisation region. A method of checking the operational state of the analytical instrument comprises generating reference ions by introducing vaporised molecules or molecule clusters of a reference compound into the ionisation region such that at least some of the vaporised reference compound molecules or molecule clusters are ionised in the ionisation region by the atmospheric pressure ion source, detecting, using the analyser, at least some of the reference ions or ions derived from the reference ions, and determining an operational state of the analytical instrument based on the detection.

### CROSS REFERENCE TO RELATED APPLICATIONS

This application is a U.S. non-provisional application which claims the benefit of priority under 35 U.S.C. § 119(a) to United Kingdom Patent Application No. GB2503313.5, which was filed Mar. 7, 2025, and which is hereby incorporated by reference in its entirety into this specification.

### FIELD OF THE INVENTION

The present invention relates to methods of checking the health status of an analytical instrument such as a mass spectrometer.

### BACKGROUND

Analytical instruments such as mass spectrometers require careful calibration and tuning. Typically, a full instrument calibration is a complex and time-consuming process that can only be performed during instrument downtime (i.e. when the instrument is not being used for sample analysis). In order to extend the necessary time intervals between full instrument calibrations, several commercial instruments are configured to perform “health checks”, which are less complex checks to determine whether or not the instrument is in a correct operational state. Such checks can be performed (e.g. periodically) as part of the routine operation of the instrument.

Existing mass spectrometer health checks can involve checking electronic readbacks of various generated voltages and radiofrequencies, as well as determining the efficiency of ionisation, ion transportation, mass selection, and mass detection by virtue of a reference compound. Only by measuring real ions can it be ensured that the instrument does not suffer from mechanical misalignments or contamination and/or charge buildup on the ion optics. For such “ion driven” instrument health checks, it is challenging to provide a robust solution without negatively impacting sample analysis.

Orbitrap™ Exploris™ instruments use a dedicated internal calibrant source (ICS) positioned between the first and second vacuum chambers, which is configured to ionise a dedicated calibration compound (e.g. FlexMix™). Ion optical elements are used to inject generated calibrant ions into the ion path, ultimately leading to the mass detector. Although this approach has proved to be a successful one, it adds cost to the instrument by requiring a relatively large amount of additional hardware.

Another approach utilises the injection of a neutral calibrant dissolved in a liquid solvent. The calibrant solution can be selectively sent to the ion source in place of the liquid flow from the LC line. This has the advantage that the calibrant ions follow the same ion path as the analyte ions. However, such a configuration interrupts the flow of analyte and can be error prone, particularly if the container filled with the calibrant solution is not gas tight.

Bruker's “Captive Nano-Spray Source” uses gas enrichment of a neutral compound for lock mass correction. However, the internal calibrant works only in positive ion mode, and the apparatus provides limited control over the calibrant signal intensity because the gas enrichment is provided by a calibrant solution doped onto a gas filter. Calibrant ions will always be present without control over their intensity which may cause suppression of the analyte signal, normally over several weeks until the gas filter (unpredictably) dries out. Refilling of the calibrant requires manual user interaction including removal of the gas filter.

It is believed that there remains scope for improvements to apparatus for and methods of operating analytical instruments such as mass spectrometers.

Summary

A first aspect provides a method of operating an analytical instrument that comprises an analyser and an atmospheric pressure ion source configured to generate analyte ions in an ionisation region, the method comprising:
checking an operational state of the analytical instrument by:
   (i) generating reference ions by introducing vaporised molecules or molecule clusters of a reference compound into the ionisation region such that at least some of the vaporised reference compound molecules or molecule clusters are ionised in the ionisation region by the atmospheric pressure ion source;
   (ii) detecting, using the analyser, at least some of the reference ions or ions derived from the reference ions; and
   (iii) determining an operational state of the analytical instrument based on the detection.

Embodiments provide an analytical instrument health check facilitated by well-controlled, on-demand generation of reference ions without the need for a second ion source. In embodiments, reference molecules and/or molecule clusters are ionised in the ionisation region of an ion source by secondary ionisation. As the reference ions are generated by the same ion source as the analyte ions, they will follow the same ion path as the analyte ions, and can be used to accurately monitor the status of the entire instrument, including the status of (i) the ionisation, (ii) the ion transportation, (iii) the ion selection, and (iv) the ion detection. Furthermore, the intensity of the reference ions can be tightly controlled by controlling the introduction of the reference compound into the ionisation region, meaning that the reference ions can be generated at times that avoid suppression of desired analyte signal.

In embodiments, the check is performed automatically by the instrument, i.e. without physical user interaction with the instrument. The check may be performed automatically as a start-up routine upon switching on the instrument and/or the check may be scheduled and performed automatically during an experiment or sequence of experiments performed by the instrument. The check may be performed repeatedly, e.g. periodically, during operation of the instrument, e.g. with a frequency greater than a frequency at which full instrument calibrations are required.

In particular embodiments, the method further comprises performing a plurality of analyte measurements, wherein each analyte measurement comprises: supplying an analyte to the ion source and generating analyte ions; and detecting, using the analyser, at least some of the analyte ions and/or ions derived from the analyte ions. Then, the step of checking the operational state of the analytical instrument may be performed between analyte measurements, e.g. automatically by the instrument without manual user interaction. In embodiments, reference ions are not generated during each of the analyte measurements.

In embodiments, the ion source is configured to generate analyte ions from a liquid flow. The instrument may comprise a pump configured to supply the liquid flow to the ion source.

For example, the analytical instrument may comprise a chromatographic separator such as a liquid chromatography (LC) separator, where the ion source is coupled to the chromatographic separator such that the ion source ionises sample received from the chromatographic separator (i.e. where the liquid flow is directed through an LC column before reaching the ion source). The liquid chromatography separator may comprise a liquid chromatography (LC) pump and a liquid chromatography column. The ion source may be configured to generate ions from the flow generated by the LC pump and pushed through the column. In these embodiments, the chromatographic separator may be configured to perform a sequence of chromatographic separation runs, and the method may be performed at the beginning of and/or end of and/or during a or each chromatographic separation run.

Additionally or alternatively, a liquid flow may be supplied to the atmospheric pressure ion source by bypassing the LC column, or by a syringe pump directly connected to the ion source (optionally without any chromatographic separator).

In general, the method may comprise controlling (e.g. adjusting) a flow rate and/or solvent composition of the liquid flow supplied to the ion source prior to and/or during the check, e.g. so as to improve the signal quality during the check. The flow rate and/or solvent composition may be controlled so that the flow rate and/or solvent composition of the liquid flow during the check is different to a flow rate and/or solvent composition of the liquid flow during each analyte measurement. For example, in embodiments, the step of checking the operational state of the analytical instrument may further comprise: setting a suitable flow rate and/or solvent composition of the liquid flow supplied to the ion source; and generating reference ions in the ionisation region, e.g. without interrupting the liquid flow to the ion source. The flow rate and/or solvent composition rate may be set to a value suitable for the check in question, e.g. to ensure a sufficient and stable ion intensity. When the check is complete, the flow rate and/or solvent composition may be returned to a value suitable for the subsequent analytical measurement. Where the chromatographic separator and the mass spectrometer (comprising the ion source and the analyser) are two separate instruments, the steps of setting a suitable flow rate and/or solvent composition and of generating and detecting ions may be triggered from one of the two instruments, and/or from an external control unit such as an external computer.

Thus, embodiments provide a method of automatically checking the operational state of an analytical instrument, where the method can be scheduled to be executed between analyte measurements without manual interaction. Such a health check that takes account of the entire system without the need for manual user interaction is particularly beneficial in embodiments where the ion source is coupled to an automated solvent delivery system such as liquid chromatography system.

In particular embodiments, the health check is performed by detecting a single ion species having a defined single mass to charge ratio (m/z). Thus, the step of (ii) detecting may comprise: detecting, using the analyser, a single ion species of the reference ions or ions derived from a single ion species of the reference ions. The single ion species may have a mass to charge ratio (m/z) between 150 Th and 250 Th, e.g. such that it is well detectable under typical operation conditions for liquid chromatography mass spectrometry (LC-MS) systems.

The step of (iii) determining may comprise: determining that the analytical instrument is in an acceptable operational state based on the detection; or determining that the analytical instrument is in an unacceptable operational state based on the detection.

The method may further comprise adjusting one or more operational parameters of the analytical instrument for subsequent operation when it is determined that the analytical instrument is in an unacceptable operational state. The one or more operational parameters may be adjusted to return the instrument to an acceptable operational state.

Additionally or alternatively, the method may comprise entering an error state when it is determined that the analytical instrument is in an unacceptable operational state and/or recalibrating the instrument when it is determined that the analytical instrument is in an unacceptable operational state.

The step of (ii) detecting may comprise: measuring a property of the reference ion(s) or the ion(s) derived from the reference ion(s). The step of (iii) determining may comprise: comparing the measured value of the property to an expected value of the property; and determining the operational state of the analytical instrument based on the comparison. The property may be, or may be indicative of, an intensity, area, peak width, and/or mass to charge ratio (m/z).

The step of (iii) determining may comprise: determining that the analytical instrument is in an acceptable operational state when the measured value of the property is equal to or differs by less than a threshold from the expected value of the property; and/or determining that the analytical instrument is in an unacceptable operational state when the measured value of the property is unequal to or differs by greater than a threshold from the expected value of the property.

For example, in particular embodiments, the method comprises measuring a transient decay and/or peak width of the reference ion(s) and comparing the measured value to an expected value; and determining whether the pressure within the mass analyser is at an acceptable level based on the comparison. Such a check may be performed repeatedly during operation of the instrument and/or may be combined with any one or more other of the checks described herein, i.e. by being based on a reference peak width while the other check(s) is based on another property of the reference peak such as its intensity.

Thus, the step of (iii) determining may comprise determining whether a pressure within the ion detector is at an acceptable level based on a measured property of the reference ion(s) or the ion(s) derived from the reference ion(s) and comparing it to an expected value; wherein
i. the measured property is the peak width, and the system is in a correct operation state only if the measured value is equal to or below an expected peak width; or
ii. the ion detector is an orbital ion trap, and the measured property is the transient decay, i.e. the decay rate of the image current signal, and the system is in a correct operation state only if the measured value is equal to or below an expected decay rate; or
iii. the ion detector measures the ions' time-of-flight, and the measured property is the decay rate of the ion signal with increasing length of the flight path and the system is in a correct operation state only if the measured value is equal to or below an expected decay rate.

The step of (ii) detecting may comprise: detecting the reference ion(s) or the ion(s) derived from the reference ion(s) multiple times during a time period to produce a measured response. The time period may be, e.g., on the order of a few seconds or tens of seconds. The step of (iii) determining may comprise: comparing the measured response to an expected response; and determining the operational state of the analytical instrument based on the comparison. The step of (iii) determining may comprise: determining that the analytical instrument is in an acceptable operational state when the measured response is the same as or sufficiently similar to the expected response; and/or determining that the analytical instrument is in an unacceptable operational state when the measured response is different from or insufficiently similar to the expected response.

The step of (ii) detecting may comprise: measuring an intensity of the reference ion(s) or the ion(s) derived from the reference ion(s) multiple times during the time period to produce a measured intensity response, wherein the expected response is an expected intensity response. The step of (iii) determining may comprise: determining that the analytical instrument is in an acceptable operational state when the measured response is stable or changes by less than a threshold amount during the time period; and/or determining that the analytical instrument is in an unacceptable operational state when the measured response is unstable or changes by greater than a threshold amount during the time period.

The step of (iii) determining may comprise: determining that the ion source is in an acceptable operational state when the measured response is stable or changes by less than a threshold amount during the time period; and/or determining that the ion source is in an unacceptable operational state when the measured response is unstable or changes by greater than a threshold amount during the time period. The step of (ii) detecting may comprise observing the intensity of the reference ion(s) or the ion(s) derived from the reference ion(s) over a period of time and the step of (iii) determining may comprise determining whether the mean intensity is greater or equal to an expected value and the variation of the intensity within the period of time is equal to or less than an expected value.

Thus, particular embodiments provide a method in which the operational state of an atmospheric pressure ion source is determined by monitoring, over a period of time, the intensity of reference ions generated by secondary ionisation of vaporised molecules or molecule clusters of a reference compound. If the intensity is stable and/or approximately equal to an expected intensity over this time, then it may be determined that the ion source is in an acceptable operational state; but if the intensity is unstable and/or sufficiently different from the expected intensity over this time, then it may be determined that the ion source is in an unacceptable operational state. As the reference ions are generated by the ion source itself, this method provides a particularly convenient and accurate method for monitoring the status of the ion source. In these embodiments, the method may comprise maintaining operational parameter(s) of the analytical instrument static during the time-period.

In general, checks based on the signal of the reference ion(s) or ion(s) derived from the reference ion(s) while keeping the operational parameters of the system constant during may include:
measuring the stability and quality of the ion generation by measuring the signal variation and signal intensity over a period of time. A high signal variation may indicate an unacceptable operational state of the pump/chromatographic separator/tubing or of the ion source.
measuring the ion signal using an orbital ion trap and measuring a transient decay, i.e. the decay rate of the image current signal, and/or peak width of the reference ion(s), and comparing the measured value to an expected value; and determining whether the pressure within the mass analyser is at an acceptable level based on the comparison. Similarly, the vacuum pressure in a time-of-flight detector may be determined based on the signal decay as a function of the length of the flight path.
measuring the m/z of the reference ion(s) or ion(s) derived from the reference ion(s) and determining whether the value(s) lie within an acceptable range.

Multiple such checks may be performed on the signal from one such measurement.

In further embodiments, the step of (ii) detecting may comprise measuring the intensity ratio between one or more ion(s) derived from the reference ion(s) and one or more reference ion(s), giving a measure of ion activation.

Additionally or alternatively, the step of determining may comprise: determining whether an ion optical element (such as a mass filter) has an acceptable amount of contamination. This check may be performed by first charging up the surface of the ion optical element by directing a large amount of ion current towards it by applying suitable DC potentials to the ion optical element and the adjacent electrodes; and then observing the signal intensity over a period of time (seconds to tens of seconds) while the ion optical element discharges during normal operation. Then, the step of (iii) determining may comprise determining whether the discharge rate is greater or equal to an expected value.

In further embodiments, the method may comprise checks based on the signal of the reference ion(s) or ion(s) derived from the reference ion(s) while varying an operational parameter of the analytical instrument over a range during the time-period such that the measured response is a response of the detected ion(s) to the variation of the operational parameter over the range, and comparing the measured response to a reference response. Thus, the method may comprise varying an operational parameter of the analytical instrument over a range during the time-period such that the measured response is a response of the detected ion(s) to the variation of the operational parameter over the range.

The expected response may be a reference response of the detected ion(s) to the variation of the operational parameter over the range. In these embodiments, the operational parameter may be the value of or a difference between two or more values of: a DC voltage magnitude, an RF voltage amplitude, an RF voltage frequency, a pressure, a time, a time period, a temperature and/or a flow rate.

For example, in particular embodiments, the method comprises:
varying the amplitude and/or frequency of an RF voltage applied to an RF ion guide or trap over a range during the time-period such that the measured response is a response of the detected ion(s) to the variation of the RF amplitude and/or frequency over the range; where the expected response is a reference response of detected ion(s) to the variation of the RF amplitude and/or frequency over the range; and/or
scanning the centre m/z of an isolation window of a mass filter (such as a quadrupole mass filter) over a range such that the measured response is a response of the detected ion(s) as a function of isolation window centre m/z over the range; where the expected response is a reference respoonse of detected ion(s) as a function of isolation window centre m/z over the range; and/or
varying the injection time (i.e. the open time of an ion gate) of ions into an ion trap over a range such that the measured response is a response of the detected ion(s) to the variation of the injection time over the range; where the expected response is a reference response of detected ion(s) to the variation of the injection time over the range; and/or
varying a waiting time (e.g. between (i) the opening of two ion gates, or (ii) the opening of one ion gate and the start time of ion detection, or (iii) the pulsing of a voltage applied to an ion optical element and the opening of an ion gate, or (iv) the pulsing of a voltage applied to an ion optical element and the start time of ion detection, or (v) the start/end times of the application of two voltages, etc.) over a range such that the measured response is a response of the detected ion(s) to the variation of the waiting time over the range; where the expected response is a reference response of detected ion(s) to the variation of the waiting time over the range; and/or
varying a magnitude of a DC voltage (e.g. a deflector voltage or a HV offset voltage) applied to a mass analyser over a range during the time-period such that the measured response is a response of the detected ion(s) to the variation of the DC voltage magnitude over the range; where the expected response is a reference response of detected ion(s) to the variation of the DC voltage magnitude over the range.

The reference response may be a measured response of the reference ion species to the variation of the operational parameter over the range. Alternatively, the reference response may be interpolated from a response of one or more different (e.g. Flexmix™) ion species to the variation of the operational parameter over the range. The reference response may have been recorded on a different instrument, or on the same instrument prior to the execution of the method.

The method may further comprise: determining, from the measured response, an improved or optimum value of the operational parameter; and setting the operational parameter to correspond with the improved or optimum value during subsequent operation of the analytical instrument.

The analytical instrument may be a mass spectrometer. The analyser may be a mass analyser. The instrument may comprise a fore vacuum chamber, and an inlet connecting the ionisation region to the fore vacuum chamber, wherein the instrument is configured such that ions generated in the ionisation region can be transported to the fore vacuum chamber via the inlet. The analyser may be arranged in a vacuum chamber of the instrument which is arranged downstream of the fore vacuum chamber. The analyser's vacuum chamber may be maintained at a lower pressure than the fore vacuum chamber. The step of determining may comprise: determining that the mass analyser is in an acceptable operational state based on the detection; or determining that the mass analyser is in an unacceptable operational state based on the detection.

The instrument may comprise: a volume housing a reference compound, which may be a volatile reference compound; a heater configured to heat the reference compound; a transfer line (which may be independent to the gas lines commonly needed for the ionisation the analyte) connecting the volume to the ionisation region; and a carrier gas source configured to supply a carrier gas.

The ion source may be configured to generate reference ions by:
the heater heating the reference compound such that vaporised molecules and/or molecule clusters of the reference compound are produced in the volume;
the carrier gas source supplying a carrier gas such that at least some of the vaporised reference compound molecules and/or molecule clusters are transported from the volume to the ionisation region via the transfer line; and
at least some of the vaporised reference compound molecules and/or molecule clusters being ionised in the ionisation region so as to generate reference ions.

The ion source may be configured to ionise analyte in the ionisation region so as to generate analyte ions. The ion source can generate analyte ions and reference ions at different times in the same ionisation region, and/or the ion source may be configured to simultaneously generate analyte ions and reference ions in the ionisation region. The analyte ions and reference ions can be transported (optionally together) from the ionisation region to the analytical instrument, i.e. via the same path.

The vaporised reference compound molecules and/or molecule clusters may be essentially electrically neutral gaseous vaporised calibrant reference compound molecules and/or molecule clusters. The ion source may be configured to ionise the vaporised reference compound molecules and/or molecule clusters by gas-phase interactions between: (i) the vaporised reference compound molecules and/or molecule clusters; and (ii) analyte ions and/or charged particles (such as charged molecules, molecule clusters or droplets) created by the ion source for generating analyte ions. The “charged particles created by the ion source for generating analyte ions” can be those charged particles created by the ion source when it is generating analyte ions from an analyte (e.g. charged analyte solution droplets in the case of an electrospray ionisation (ESI) ion source electrospraying an analyte solution), or can be charged particles created by the ion source when it is not generating analyte ions but is being operated in a manner that would generate analyte ions were an analyte present (e.g. charged solvent droplets in the case of an ESI ion source electrospraying a solvent that does not contain analyte). In ESI, independent of the presence of analyte, the electrospray process produces charged particles such as charged droplets having an excess of positive (or negative) charges when the spray needle is held at a positive (or negative) high voltage relative to the supplied cone voltage. It is the nature of the ESI process that the excess of positive or negative charge drives creation of clusters of charged particles that leads in turn to the highly efficient ionisation of solvent clusters and/or analyte molecules.

Thus, where the ion source is configured to generate analyte ions from an analyte solution, the ion source may be configured to ionise the vaporised reference compound molecules and/or molecule clusters by gas-phase interactions (e.g. charge transfer) between: (i) the vaporised reference compound molecules and/or molecule clusters; and (ii) analyte ions and/or charged particles (such as charged molecules, clusters, and/or droplets) created from the analyte solution.

The ion source may be configured to generate ions by atmospheric pressure chemical ionisation (APCI), electrospray ionisation (ESI), nano-ESI, liquid matrix assisted laser desorption ionisation (liquid MALDI), atmospheric pressure photo ionisation (APPI), direct analysis in real time (DART), atmospheric pressure laser ionisation (APLI), or any combination thereof. In particular embodiments, the ion source is configured to generate ions by electrospray ionisation (ESI).

In some embodiments, where the ion source is an electrospray ionisation (ESI) ion source comprising an electrospray ionisation (ESI) needle, an analyte source (such as a liquid chromatography (LC) separator) may be configured to supply analyte solution to the electrospray ionisation (ESI) needle, and the electrospray ionisation (ESI) needle may be configured to generate analyte ions in the ionisation region by electrospraying the analyte solution. The ion source may be configured to ionise reference compound molecules by gas-phase interactions between charged particles (e.g. droplets and/or ions) created by the electrospray ionisation (ESI) needle and the vaporised reference compound molecules and/or molecule clusters, i.e. by secondary electrospray ionisation (SESI).

The reference compound may be a volatile compound. The reference compound may be solid at room temperature and atmospheric pressure (e.g. at a temperature of about 20° C. (293 K, 68° F.) and an absolute pressure of about 1 atm (15 psi, 101 kPa). The reference compound may be solid when not heated by the heater.

The reference compound may be configured to produce positively charged reference ions under positive soft ionisation conditions or negatively charged reference ions under negative soft ionisation conditions. The reference compound may comprise at least one functional group that can be ionised under positive soft ionisation conditions and at least one further functional group that can be ionised under negative soft ionisation conditions.

The reference compound may comprise at least one proton acceptor group and at least one proton donor group. The at least one proton acceptor group may comprise an amino group or heterocyclic nitrogen and/or the at least one proton donor group may comprise a carboxylic acid group, or sulfonic acid group or hydroxy group. The at least one proton acceptor group may comprise a hetero aromatic functionality.

The reference compound may have at least one of (i) an acidic dissociation constant (pKa) of 2 to 6, such as around 4, (ii) a melting point of 80 to 300° C., such as 80 to 160° C., and (iii) a molar mass of 190 to 500 Da.

The reference compound may be selected from: amino acids and derivatives or metabolites of amino acids. The amino acids may be selected from phenylalanine, tyrosine, proline, arginine, histidine, and tryptophan. The derivatives or metabolites of amino acids may be selected from Tyrosine derivatives or metabolites and Tryptophan derivatives or metabolites. The derivatives or metabolites of amino acids may be selected from Tyrosine methyl ester, O-Methyl L-Tyrosine, 4-Methoxy-L-phenylalanine, 5-Hydroxy-L-tryptophan, Indole derivatives having acid groups, 3-Indole alkyl acids, 3-Indole propionic acid, 3-Indole acetic acid, 1-Indole propionic acid, 2-Methyl-3-indole acetic acid, 5-Hydroxy indole-3-acetic acid, 3-Indole acrylic acid, Indole-3-sulfonic acid, 3-Hydroxykynurenine, or 3-Hydroxyanthranilic acid.

One or more atoms of the reference compound may be isotopically enriched and/or may carry one or more halogen atoms as a substituent.

The heater may be configured to heat the reference compound to a set temperature. The set temperature may be selected to cause the reference compound to generate vaporised (i.e. gaseous) reference compound molecules and/or molecule clusters (e.g. to sublimate) in the volume.

The ion source may further comprise a temperature sensor configured to measure the temperature of the volume and/or of the reference compound. The ion source may be configured to control the heater based on the temperature measured by the temperature sensor, i.e. so as to maintain the volume and/or the reference compound at the set temperature.

The carrier gas may be an inert gas such as nitrogen, i.e. so that the carrier gas is not ionised by the ion source. The carrier gas source may be configured to supply the carrier gas to the volume. The ion source may be configured such that the vaporised reference compound molecules and/or molecule clusters are transported from the volume to the ionisation region by a flow of the carrier gas from the volume to the ionisation region.

The ion source may be configured to control generation of reference ions by controlling the heater and/or by controlling a flow of the carrier gas.

For example, the ion source may be configured to initiate (i.e. to turn on) generation of reference ions by increasing the temperature of and/or turning on the heater, i.e. such that vaporised reference compound molecules and/or molecule clusters are produced in the volume. The ion source may be configured to stop (i.e. to turn off) generation of reference ions by reducing the temperature of and/or turning off the heater, i.e. such that vaporised reference compound molecules and/or molecule clusters are not produced in the volume.

Additionally or alternatively, the ion source may be configured to initiate (i.e. to turn on) generation of reference ions by increasing or initiating a flow of the carrier gas from the volume to the ionisation region, i.e. such that vaporised reference compound molecules and/or molecule clusters are transported from the volume to the ionisation region via the transfer line. The ion source may be configured to stop generation of reference ions by reducing or stopping the flow of the carrier gas from the volume to the ionisation region, i.e. such that vaporised reference compound molecules and/or molecule clusters (where present) are not transported from the volume to the ionisation region via the transfer line.

The ion source may be configured to generate a target intensity of reference ions by adjusting a set temperature for the heater; and/or by adjusting a set flow level of the carrier gas. The target intensity can be set as desired. The target intensity can be set at a fixed value (e.g. during each experiment) or may be variable (e.g. may be varied during an experiment). For example, two (or more) different target intensities may be set during an LC run, e.g. (i) at times when no analytes are eluting from the column, and (ii) when analytes are eluting from the column. The target intensity can be set to avoid a too high reference ion signal, which might otherwise negatively interfere with the detection of analytes.

The ion source may further comprise a valve arranged between the carrier gas source and the volume. The valve may be configured to control the supply of carrier gas to the volume. The ion source may be configured to control generation of reference ions by controlling the valve. For example, the ion source may be configured to initiate (i.e. to turn on) generation of reference ions by opening the valve. The ion source may be configured to stop (i.e. to turn off) generation of reference ions by restricting or closing the valve.

According to another aspect, there is provided a method of operating an analytical instrument that comprises an analyser and an ionisation region, the method comprising:
checking an operational state of the analytical instrument by:
   (i) generating reference ions in the ionisation region;
   (ii) detecting, using the analyser, a single ion species of the reference ions or ions derived from a single ion species of the reference ions multiple times during a time period to produce a measured response;
   (iii) comparing the measured response to an expected response; and
   (iv) determining the operational state of the analytical instrument based on the comparison.

This aspect can, and in embodiments does, include any one or more or each of the optional features described herein.

For example, the instrument may further comprise a pump configured to supply a liquid flow of solvent and/or analyte to the atmospheric pressure ion source, and the ion source may be configured to generate analyte ions from the liquid flow, e.g. as described above. The method can be scheduled to be executed in between measurements of the analyte without manual interaction, e.g. as described above.

A further aspect provides a non-transitory computer readable storage medium storing computer software code which when executed on a processor performs the method(s) described above.

A further aspect provides a control system for an analytical instrument such as a mass spectrometer, the control system configured to cause the analytical instrument to perform the method(s) described above.

A further aspect provides an analytical instrument, such as a mass spectrometer, comprising the control system described above.

### DESCRIPTION OF THE DRAWINGS

Various embodiments will now be described in more detail with reference to the accompanying Figures, in which:

FIG. 1 shows schematically a mass spectrometer in accordance with embodiments;

FIG. 2 shows schematically detail of a mass spectrometer in accordance with embodiments;

FIG. 3 shows schematically detail of an electrospray ion source in accordance with embodiments;

FIG. 4A shows mass spectrum of the secondary electrospray ionisation of Tyrosine methyl ester in positive polarity mode, and FIG. 4B shows a mass spectrum of the secondary electrospray ionisation of Tyrosine methyl ester in negative polarity mode;

FIG. 5A shows a mass spectrum of the secondary electrospray ionisation of Indole-3-acetic acid in positive polarity mode, and FIG. 5B shows a mass spectrum of the secondary electrospray ionisation of Indole-3-acetic acid in negative polarity mode;

FIG. 6A shows a mass spectrum of the secondary electrospray ionisation of Indole-3-propionic acid in positive polarity mode, and FIG. 6B shows a mass spectrum of the secondary electrospray ionisation of Indole-3-propionic acid in negative polarity mode;

FIG. 7A shows the chemical structure of 3-indole acetic acid, FIG. 7B shows the chemical structure of Indole-3-acetic-2,2-d2 acid, and FIG. 7C shows the chemical structure of 5-Fluoroindole-3-acetic acid;

FIG. 8 is a simplified sketch of a normalised signal intensity versus DC voltage scan illustrating how the optimal tuning of the DC voltage may change over time;

FIG. 9 shows measured RF transmission profiles for several reference ions;

FIG. 10 shows response curves for tuning of the DC offset for a linear ion guide; and

FIG. 11 illustrates a method in accordance with embodiments.

### DETAILED DESCRIPTION

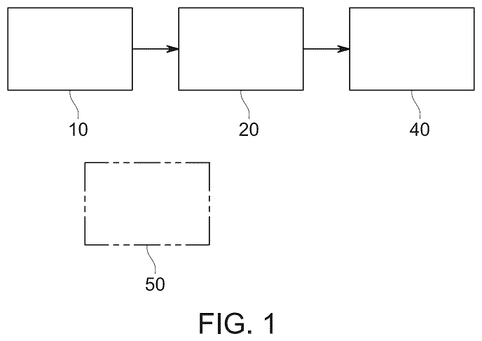

FIG. 1 illustrates schematically an analytical instrument, such as a mass spectrometer, that may be operated in accordance with the methods described herein. As shown in FIG. 1, the instrument includes an ion source 10, a mass filter 20, and a mass analyser 40.

The ion source 10 is configured to generate ions from a sample. The ion source 10 may optionally be coupled to a separation device such as a liquid chromatography (LC) separation device or a capillary electrophoresis separation device (not shown), such that the sample which is ionised in the ion source 10 is a sample solution from the separation device. The composition of the sample solution's solvent can be altered over time, i.e. during each chromatographic separation cycle.

The mass filter 20 is arranged downstream of the ion source 10 and is configured to receive ions from the ion source 10. The mass filter 20 is configured to filter the received ions according to their mass to charge ratio (m/z). The mass filter 20 may be configured such that received ions having m/z within an m/z transmission window (or “isolation window”) of the mass filter are onwardly transmitted by the mass filter, while received ions having m/z outside the m/z transmission window are attenuated by the mass filter, i.e. are not onwardly transmitted by the mass filter. The width and/or the centre m/z of the transmission window may be controllable (variable), e.g. by suitable control of RF and/or DC voltage(s) applied to electrodes of the mass filter 20. Thus, for example, the mass filter 20 may be operable in a transmission mode of operation, whereby most or all ions within a relatively wide m/z window are onwardly transmitted by the mass filter 20, and a filtering mode of operation, whereby only ions within a relatively narrow m/z window (centred at a desired m/z) are onwardly transmitted by the mass filter 20. The mass filter 20 can be any suitable type of mass filter, such as a quadrupole mass filter.

The mass analyser 40 is arranged downstream of the mass filter 20. The mass analyser 40 is configured to analyse received ions so as to determine their mass to charge ratio (m/z) and/or mass, i.e. to produce a mass spectrum of the ions. The mass analyser 40 can be any suitable type of mass analyser, such as an ion trap mass analyser, an electrostatic orbital trap mass analyser (such as an Orbitrap™ FT mass analyser as made by Thermo Fisher Scientific), a time-of-flight (ToF) mass analyser such as a multi-reflecting time-of-flight (MR-ToF) mass analyser, or a quadrupole mass analyser. Numerous other types of mass analyser are possible.

It should be noted that FIG. 1 is merely schematic, and that the analytical instrument can, and in embodiments does, include any number of one or more additional components. For example, the instrument may include one or more ion transfer stage(s) arranged between any of the illustrated components, e.g. including an atmospheric pressure interface and/or one or more ion guides, lenses and/or other ion optical devices configured such that some or all of the ions can be transmitted appropriately through the instrument. The ion transfer stage(s) may include any suitable number and configuration of ion optical devices, for example optionally including one or more ion guides, lenses and/or other ion optical devices.

In some embodiments, the analytical instrument includes a collision or reaction cell for fragmenting or reacting ions, e.g. arranged downstream of the mass filter 20, and the ions analysed by the analyser 40 can be fragment or product ions produced by fragmenting or reacting parent ions generated by the ion source 10.

As also shown in FIG. 1, the instrument is under the control of a control unit 50, such as an appropriately programmed computer, which controls the operation of various components of the instrument including the analyser 40. The control unit 50 may also receive and process data from various components including the detector(s) in accordance with embodiments described herein.

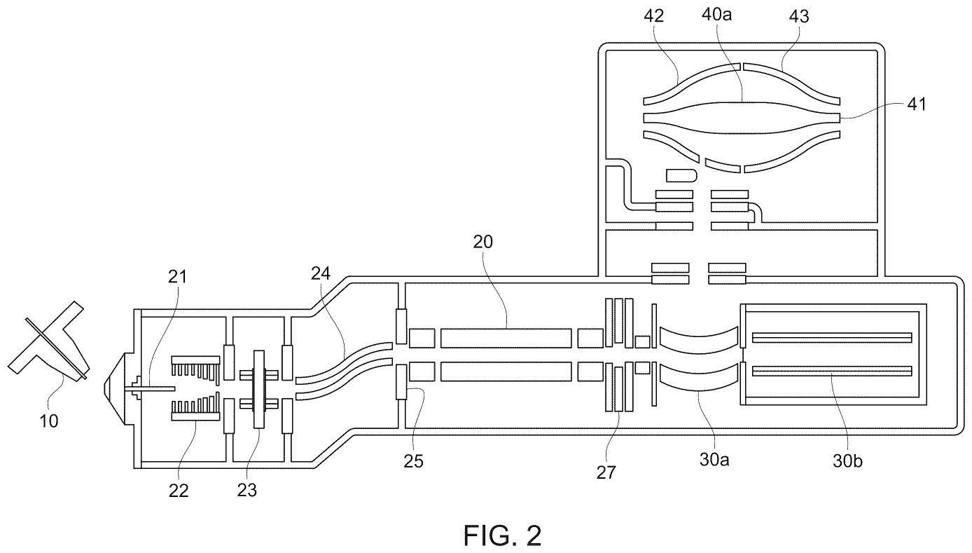

FIG. 2 shows in more detail an example instrument that may be operated in accordance with embodiments. It will be understood that the instrument shown in FIG. 2 is a non-limiting example, and that numerous variations are possible.

As shown in FIG. 2, the instrument's ion source 10 is an electrospray ionisation (ESI) ion source. The ESI ion source is configured to ionise a sample by electrospraying a sample solution. To do this, a high voltage is applied to an electrospray needle of the ESI ion source and a nebulising gas is supplied to the ESI ion source, such that the ESI ion source produces a charged aerosol of the analyte solution. The needle and/or nebulising gas can be heated.

The instrument includes a vacuum interface, which includes a transfer tube 21, an ion funnel 22, a quadrupole pre-filter ion guide 23, and a “bent flatapole” ion guide 24. The bent flatapole ion guide 24 may be of the design described in U.S. Pat. No. 9,536,722.

The instrument also includes a mass filter in the form of a quadrupole mass filter 20, an ion trap 30a in the form of a curved linear ion trap (“C-Trap”), and a collision cell 30b in the form of an ion routing multipole collision cell (“IRM”). lons from the ion source 10 can be accumulated in the C-Trap 30a and/or collision cell 30b by opening and closing a “split-lens” gating electrode located in a charge detector assembly 27, which is arranged between the C-Trap 30a and the mass filter 26.

The instrument also includes a mass analyser 40 in the form of an orbital ion trap mass analyser. As shown in FIG. 2, the orbital trap 40 comprises an inner electrode 41 elongated along the orbital trap axis and a split pair of outer electrodes 42, 43 which surround the inner electrode 41 and define therebetween a trapping volume. The pair of outer electrodes 42, 43 also function as detection electrodes to detect an image current induced by the oscillation of the ions in the trapping volume and thereby provide a detected signal. The detected signal can be processed using Fourier transformation to obtain a mass spectrum of ions within the trap.

Once accumulated in the ion trap 30a and/or collision cell 30b, ions can be ejected into the mass analyser 40 for analysis, e.g. via one or more lenses such as a Z-lens, and a deflector electrode. Ions collected in the ion trap 30a can either be ejected orthogonally to the mass analyser 40 without entering the collision or reaction cell 30b, or the ions can be transmitted axially to the collision or reaction cell 30b for processing before returning the processed ions to the ion trap 30a for subsequent orthogonal ejection to the mass analyser 40. The processing may comprise, for example, fragmenting the ions by collisions with a collision gas and/or a reagent in the collision cell 30b, or further cooling the ions by collisions with a gas at lower energies that do cause the ions to fragment.

The instrument may be operated such that successive batches of ions from the ion source 10 are each accumulated, optionally processed, and then mass analysed by mass analyser 40 (as used herein, the accumulation of a batch of ions, its optional processing, and its subsequent ejection into and analysis by the mass analyser is termed a mass analysis “scan”). The sequence of mass analysis scans can be parallelised, e.g. by accumulating and optionally processing a batch of ions at the same as the previous batch of ions is being analysed by the mass analyser. Each scan can have any suitable time duration, such as for example, around 500 ms or less.

It is desirable that each batch of ions analysed by the mass analyser 40 includes as many ions as possible, so as to improve the statistics of the mass spectrum. However, undesirable space charge effects can occur at relatively high ion concentrations and can limit mass resolution and mass accuracy. Therefore, the total number of ions accumulated is controlled to optimise the number of ions injected into the mass analyser 40 to be below, but as close as possible to, a limit such as a space-charge limit for the ion trap 30 and/or for the mass analyser 40. Typically, between 1e4 and 1e6 elementary charges should be stored, such as between 1e5 and 5e5.

Therefore, the instrument can use so-called automatic gain control (AGC) techniques to precisely control the total number of ions accumulated in the ion trap 30. These techniques typically rely on a real-time estimation of the present ion current J or ion flux being received by the ion trap 30. Then, by controlling the injection time Tf of ions into the ion trap 30, the total number of ions or the total amount of charge accumulated in the trap 30 (and injected into the mass analyser 40) can be suitably controlled.

Thus, a batch of ions that is to be injected into the mass analyser 40 is first stored in the ion trap 30, where its total charge Q=J*Tf can be determined by the ion trap injection time Tf during which the ion trap 30 receives an ion current J from the ion source 10. The injection time (e.g. fill time) of ions in the trap 30 is adjusted based on an estimation of the present ion current J or ion flux to control the total number of ions accumulated in the ion trap. In this way, the total number of ions N injected into the mass analyser 40 per scan can be controlled in order to achieve an appropriate signal-to-noise ratio while avoiding adverse space-charge effects caused by the ion trap and/or analyser overfilling.

Embodiments provide a method for confirming the health status of an analytical instrument such as the mass spectrometer of FIGS. 1 and/or 2. Instrument health of a mass spectrometer includes the fidelity of (i) the ionisation (e.g. by ion source 10), (ii) the ion transportation (e.g. by one or more or each of the ions guides 22, 23, 24), (iii) the mass selection (e.g. by mass filter 20), and (iv) the mass detection (e.g. by mass analyser 40). Reference ions (such as calibrant ions) are introduced into the mass spectrometer from the ion source 10 and are used to carry out an instrument health check which not only evaluates the efficiency of ionisation, ion transportation, ion detection and the accuracy of the mass calibration, but also provides adjustment of instrument tuning, and compensating for deterioration of instrument performance.

In particular embodiments, as will be described further below, reference ions are used to assess the instrument health by monitoring the constant ion flux of a single reference ion species—or generally fewer species of reference ion than would be required for a full calibration of the instrument.

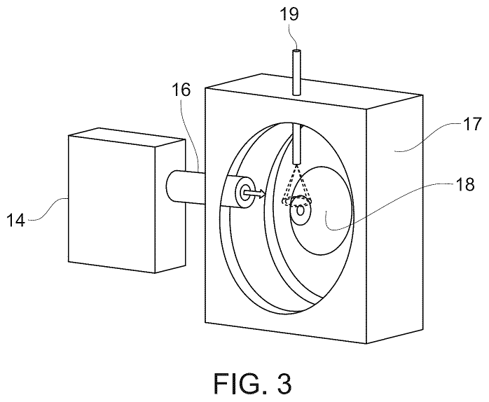

FIG. 3 shows detail of an embodiment of an electrospray ionisation (ESI) ion source 10 that may be used in accordance with embodiments. The ESI source includes an electrospray needle 19 that is configured to electrospray an analyte solution such that analyte ions are generated in the ion source chamber 17. An inlet 18 to the mass spectrometer is provided in the chamber 17, so that analyte ions (and reference ions) can be transferred from the chamber 17 to the mass spectrometer.

A compound oven 14 is connected to the ion source chamber 17 by a transfer line 16. A reference compound, which may be a volatile, e.g. solid compound, is stored in the oven. At a set temperature of the oven, the compound sublimates into the gas phase, enriching the headspace within the oven volume. An inert carrier gas source, which may be coupled to a pressure-controlled valve, can provide a controlled gas flow of inert carrier gas to the ion source chamber 17 via the oven 14 and the transfer line 16, so that the carrier gas enriched by the vapor of the volatile compound enters the ionisation volume 17 of the electrospray source.

Ionisation of the vaporised (i.e. gaseous) compound occurs in the ionisation volume 17 via secondary electrospray ionisation (SESI). The SESI method relies on the gas-phase interaction between charged particles created by electrospray ionisation (ESI) and neutral vaporised sample molecules (see, e.g., Anal. Chem. 2000, 72, 396-403). The primary ions, generated by the ion source, react with the neutral vaporised compound molecules within the ion source's volume 17. The ionised volatile compound then enters the mass spectrometer, optionally simultaneously with the analyte ions generated by electrospray.

The vaporised compound may be ionised to produce negatively or positively charged reference ions depending on the set polarity of the ion source. The ion source produces positive (or negative) ions when the spray needle is held at a positive (or negative) high voltage relative to the cone voltage.

The ion source provides well-controlled, on-demand generation of reference ions without the need for a second ion source. As the reference ions are generated in the same ionisation region 17 as the analyte ions, they will follow the same ion path as the analyte ions, and so they can be used to monitor the status of the entire instrument, including the status of (i) the ionisation, (ii) the ion transportation, (iii) the mass selection, and (iv) the mass detection. Furthermore, the intensity of the reference ions can be tightly controlled by controlling the heater and/or by controlling a flow of the carrier gas (because the volatility of the compound is controlled by the oven temperature, and the carrier gas flow determines if the compound either remains inside the oven 14 or is transferred into the ionisation volume 17)

The reference compound can be selected as desired. Particular embodiments make use of a neutral organic solid compound with a high vapor pressure, which sublimates into the gas phase to be ionised by secondary ionisation by the ion source. The neutral compound may have the following properties:
The compound may be amphoteric: it can react both as an acid and a base, producing either positively or negatively charged reference ions from a single chemical compound.
The chemical structure of the compound can include at least two functional groups:
   At least one functional group of the neutral compound may be preferentially ionised under positive soft ionisation conditions (e.g. positive soft ESI conditions) to produce a positively charged ion with a known m/z value. An example of such a functional group that may be preferentially ionised under positive soft ionisation conditions is a proton acceptor group. Examples of suitable proton acceptor groups are an amine group, which may be a primary, secondary or tertiary amine group, such as a terminal amine group, and/or a heterocyclic or heteroaromatic nitrogen atom. The presence of the proton acceptor group may render the compound basic, e.g. slightly basic. The at least one proton acceptor group comprising a hetero aromatic functionality may comprise enhanced proton affinity due to the presence of a hetero atom providing higher electron density.
   At least one functional group of the neutral compound may be preferentially ionised under negative soft ionisation conditions (e.g. negative soft ESI conditions) to produce a negatively charge ion with a known m/z value. An example of such a functional group that may be preferentially ionised under negative soft ionisation conditions is a proton donor group, such as a carboxyl group, or sulfonic acid group, or hydroxy group. The presence of the proton donor group may render the compound acidic, e.g. slightly acidic. Some proton donor functionality can be stabilized by resonance such as in a phenol functionality. This is because the phenoxide ion (C₆H₅O⁻), which forms when phenol loses a proton (H⁺), is stabilized by resonance. This stabilization makes it easier for phenol to donate a proton, thus acting as a stronger acid compared to aliphatic alcohols.
The compound may be a non-volatile solid with a low vapor pressure (e.g. <20 Pa) at room temperature and atmospheric pressure. The compound may undergo sublimation when heated, i.e. transition directly from solid to gas phase.
The melting point of the compound may be between 80° C. and 300° C., such as between 80° C. and 160° C., or between 80° C. and 110° C. The lower limit of the melting point in the forementioned ranges may be higher than 80° C., such as 100° C.
The compound may be chemically stable, such that it will not react or decompose at room temperature as well as at elevated temperatures, e.g. up to 150° C.
The acidity/basicity of the functional groups may be such that ions are generated under a wide range of solvent compositions and pH values commonly used in liquid chromatography-mass spectrometry (LC-MS). The acidic dissociation constant pKa is a quantitative measure of the strength of an acid in solution; it is the equilibrium constant for the dissociation of the acid into a solvated proton and the corresponding base. In embodiments, the reference compound is a neutral compound for ionisation with weak acidic properties. If the pKa of the compound is too low (e.g. pKa<1) then the protonation probability is expected to be very low and the ionisation efficiency in the positive polarity mode is expected to be low and the corresponding reference ion intensity too weak. If the pKa of the neutral compound is too high (e.g. pKa>7), then the dissociation of the compound can be expected to be too low and the deprotonation of the neutral compound in the negative polarity mode of the electrospray will be very inefficient. In embodiments, the reference compound has a pKa value in a range of 2-6, for example a pKa of 4 or around 4.
The acidic functionality can be a carboxylic acid group optionally with varying alkyl chain length, or can be a sulfonic acid group optionally with varying alkyl chain length, or can be a phenol group.
The compound may be soluble in both water and organic solvents. However, the compound is not provided as a solution in the analytical instrument, for example in the volume housing the compound, but rather as a solid that can be vaporised by heating.
The compound may be provided as a pure substance in the solid state. Thus, no other compounds are introduced into the ion source when the solid compound is heated. In some embodiments, a solid mixture consisting essentially of two or more compounds may be used.
The compound should typically not be a hazardous, toxic, carcinogenic compound or a compound otherwise persistent in the environment.
The compound should typically be naturally occurring.
In some embodiments, to mass selectively separate the neutral compound from any analytes of the intended application, one or more atoms of the compound can be isotopically enriched, such as deuterated, and/or the compound may carry a substituent such as one or more halogen atoms, for example fluorine.
The compound may be relatively cheap and readily available.
The compound may have a molar mass in the range 190 to 500 Da. The compound may provide one major mass peak both in positive and negative ionisation modes, e.g. in the mass range between 190-500 Th, and more typically between 150 and 250 Th.

The feasibility of an instrument health check method using secondary ionisation was tested for several volatile and solid compounds having the above-described chemical properties. The compounds which delivered the best results were:
Amino acids and derivatives or metabolites of amino acids. The derivatives may be esters of the amino acids.
In particular, the following amino acids: phenylalanine, tyrosine, proline, arginine, histidine, tryptophan.
In particular, Tyrosine derivatives, such as Tyrosine methyl ester or 4-Methoxy-L-phenylalanine or O-Methyl L-Tyrosine, or Methyl L-tyrosinate.
In particular, Tryptophan derivatives such as 3-Indole alkyl acids.
In particular 5-Hydroxy-L-tryptophan.
In particular tryptophan metabolites such as 3-Hydroxykynurenine, 3-Hydroxyanthranilic acid.
In particular, Indole derivatives having acid groups, such as carboxyl or sulfonic acid functional groups.
In particular, 3-Indole alkyl acids such as 3-Indole propionic acid or 3-Indole acetic acid.
In particular 1-Indole propionic acid.
In particular 2-Methyl indole 3 acetic acid, 5-Hydroxy indole-3-acetic acid, or 3-Indole acrylic acid.
In particular Indole-3-sulfonic acid.
In some embodiments, the compound may be a phytohormone, or a product of gut microbiota metabolism.
Other compounds of use may include: 4-Hydroxyphenylacetic acid, 3,4-Dihydroxyphenylacetic acid, Homovanillic acid, 4-Hydroxyphenylpyruvic acid, Cholic acid and cholate derivatives thereof, or Glycyrrhizin.

Each solid compound was placed in a crucible which can be heated up to a set temperature. A flow of nitrogen gas was blown over the head space of the crucible so as to transport the nitrogen gas enriched with the volatile compound towards the entrance of the ion transfer tube. A liquid flow of either FlexMix™ delivered by a syringe pump, or a mixture of water and acetonitrile plus formic acid delivered by a HPLC pump, was ionised by electrospray ionisation (ESI). The reference gas enriched with the volatile neutral compound was caused to overlap with the ESI plume of the ionised fluid.

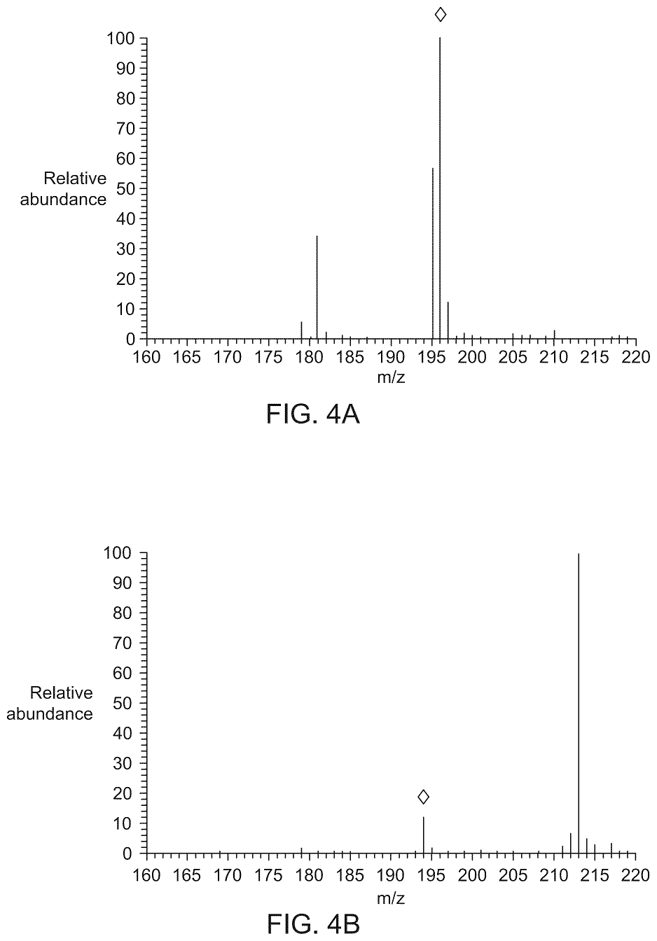

FIG. 4 shows two mass spectra of sublimed L-Tyrosine methyl ester ionised by SESI in a plume of Flexmix™ in either positive (FIG. 4A) or negative (FIG. 4B) polarity. The corresponding singly protonated (m/z 196) and de-pronated (m/z 194) Tyrosine methyl ester ions are indicated by a diamond in FIG. 4. Also visible are caffeine (m/z 195.087) and several contaminant peaks from the FlexMix™ solution.

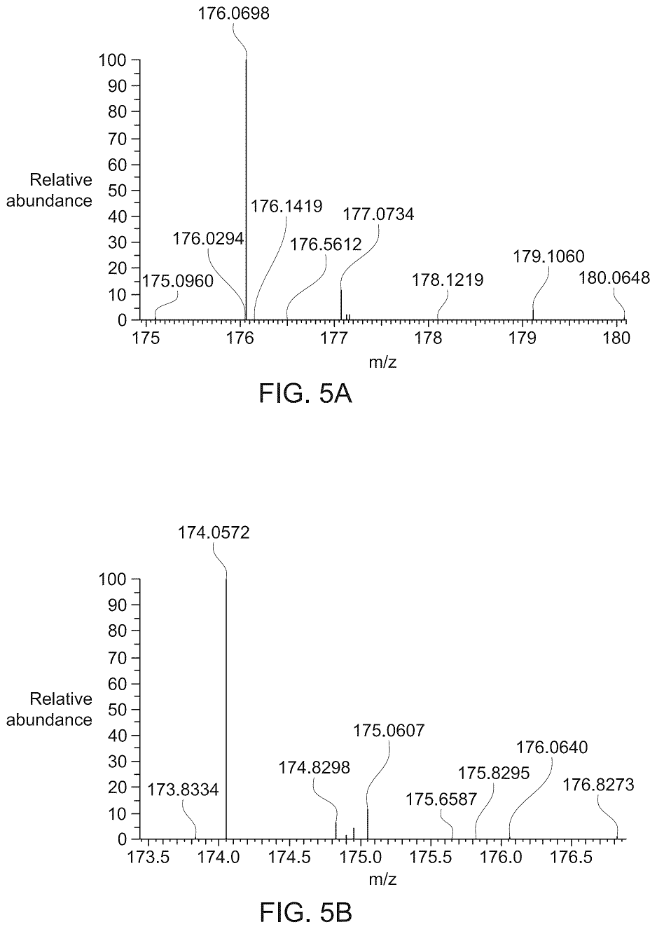

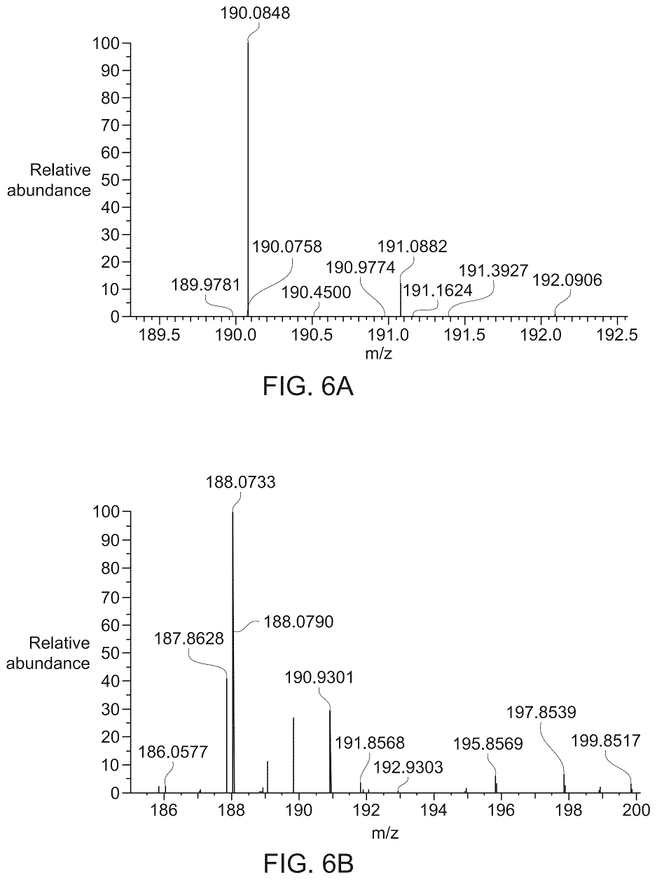

FIGS. 5 and 6 show the mass spectra of two 3-Indol alkyl acids sublimed and ionized by SESI in a plume of electrospray ionised liquid solvent from the LC (0.1% formic acid and 50% acetonitrile in water) in positive and negative polarity. FIG. 5A is for Indole-3-acetic acid in positive polarity, FIG. 5B is for Indole-3-acetic acid in negative polarity, FIG. 6A is for Indole-3-propionic acid in positive polarity, and FIG. 6B is for Indole-3-propionic acid in negative polarity. Both compounds (3-Indole acetic acid and 3-Indole propionic acid) are known metabolites of the amino acid Tryptophan.

These indole compounds are common target compounds in LC-MS analysis, meaning that the ion signal of indole reference compounds (ionised by SESI) may result in false positives for the identification of such compounds if the reference is doped into the electrospray plume during the LC run. To avoid this issue, isotope enrichment of the reference compound can be used to shift its mass away from the target compound, allowing differentiation between the target compound and the reference.

Another method for decreasing and/or increasing the m/z without significantly changing the chemical properties of the compound is the substitution of one or more hydrogen atoms at one or more of the aromatic rings by one or more fluorine atoms.

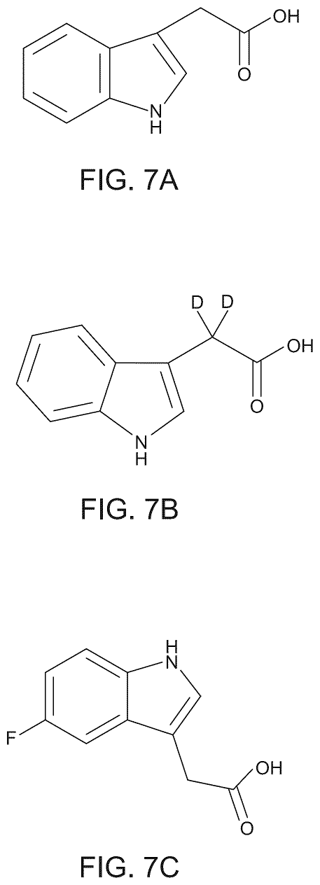

FIG. 7 shows the chemical structure of 3-indole acetic acid, Indole-3-acetic-2,2-d2 acid and 5-Fluoroindole-3-acetic acid. In addition to the unaltered 3-indole acetic acid (FIG. 7A), FIG. 7 shows the chemical structure of two candidates for differentiable reference compounds: Indole-3-acetic-2,2-d2 acid (FIG. 7B) and 5-Fluoroindole-3-acetic acid (FIG. 7C).

Further embodiments use Indole-3-sulfonic acid, with a chemical formula of C8H7NO3S. The advantage of this sulfonic acid (with a molecular weight of 197 g/mol) lies in its isotopic fine structure which enables the 34S Isotope to be differentiates from the 2× 13C isotope by high resolution mass spectrometry. This means that, for instruments with mass selecting isolation capabilities, the coalescence test (with MRFA) need not be run, but instead only this 1-point compound test can be run.

In further embodiments, to detect the coalescence limit, a 50: 50% mixture of a molecule and its singly-deuterated version can be used.

In embodiments, the main ESI spray can be generated by any of a wide range of solvent flows: most commonly an LC pump is connected to the instrument to supply one or more solvent species. Embodiments are expected to work best, i.e. the observed reference ion flux is expected to be strongest, when a solvent mixture is supplied that is optimised for the reference compound, e.g. Methanol+0.1% Formic Acid. However, reference ion signal can be observed for a wide range of organic versus aqueous solvent content and pH values. This has the benefit that for almost any application and/or sample, at least one of the applied solvents is also suitable to generate reference ion signal.

As mentioned above, in embodiments, the reference ions produced via SESI can be used to assess the instrument health by monitoring the constant ion flux of a single reference ion—or generally many fewer reference ions than would be required for a full calibration of the instrument.

The instrument health check may include one or more or each of the following checks 1-12.
1. Checking the tuning of the electrospray conditions, i.e. whether the ESI high voltage (HV) and/or the source gas setting(s) provide acceptable reference signal intensity, e.g. for different solvent compositions.
   This test monitors the signal intensity measured by the analyser 40 and the variation of the signal intensity over several scans (e.g. for a total time of around 30 s). The root mean square (RMS) of the signal intensity should typically be below about 15% when appropriate electrospray conditions are set (i.e. source gas flow rate(s), needle voltage, heater temperature, etc.). Without good spray stability, the fidelity of the peak shapes of analytes eluting from the LC will suffer.
   This test could be performed without reference ions if sufficient background ions were present, but the reference ions facilitate a more stable (because the reference signal depends less on the solvent composition than background ions), more reproducible (because the reference signal does not depend on ambient/lab conditions), and more accurate (because the reference signal will yield a defined and low injection time from the AGC mechanism) measurement.
2. Checking the tuning of the DC voltage offsets of one or more ion optical elements.
   Various ones of the instrument's ion optical elements may receive one or more DC voltage offsets, e.g. in the form of electrical potentials applied to an ion guiding device (such as the flatapole 24), an ion selecting device (such as the mass filter 20), an ion trapping device (such as the C-Trap 30a), an ion lens, and/or an ion collecting device (such as the ion funnel 22).
   This test scans the DC offset in question over a certain range of values and monitors the signal intensity measured at the mass analyser for each DC offset value. The signal intensity may be defined as the total signal or the signal for one or more individual ion species. The test then compares the so-produced curve against a reference curve. The reference curve for the reference ion (or for an ion of similar m/z and similar charge state) is recorded beforehand, e.g. during the full system calibration, or may be the result of data averaged across a multitude of similar calibrated instruments.
3. Checking the RF transmission profile for the reference ions.
   Various ones of the instrument's ion optical elements may receive one or more RF voltages, such as for example one or more ion guide(s) and/or trapping device(s).
   This test scans the amplitude and/or frequency of the RF voltage in question over a certain range of values and monitors the signal intensity measured at the mass analyser for each value. The signal intensity may be defined as the total signal or the signal for one or more individual ion species. The test then compares the so-produced curve against a reference curve. The reference curve for the reference ion (or for an ion of similar m/z and similar charge state) is recorded beforehand, e.g. during the full system calibration, or may be the result of data averaged across a multitude of similar calibrated instruments. The curves may be compared in the q-space of a Mathieu diagram.
4. Checking the isolation shapes of a mass selecting device or mass analyser.
   This test evaluates the isolation calibration of a mass selecting device (e.g. the quadrupole 20) by scanning the isolation window across the reference peak for one or more isolation widths, e.g. so as to produce an isolation profile (reference ion intensity as function of centre m/z). The measured centre m/z and isolation width are compared to specifications. The measured isolation profile may itself also be compared to a reference curve, which may have been previously acquired for the reference ion (or for an ion of similar m/z and similar charge state), e.g. during the full system calibration of the instrument, or averaged across a multitude of similar calibrated instruments.
5. Checking the fidelity of an ion gate (e.g. of the ion gate located in the charge detector assembly 27), i.e. checking whether ions are being properly blocked by the ion gate, and/or checking that the injection time dependence on ion transmission is as expected.
   A first version of this test may check the amount of residual ion signal when the ion gate is fully closed. It may also check the dependency of the ion signal on the blocking voltage by scanning the latter while monitoring the ion signal.
   A second version of this test may scan the injection time (i.e. gate open time) across a certain range of values, while monitoring the ion signal. The test may then compare the so-produced curve against a reference curve. The reference curve for the reference ion (or for an ion of similar m/z and similar charge state) may be recorded beforehand, e.g. during the full system calibration, or may be the result of data averaged across a multitude of similar calibrated instruments. This test may be used to determine a dead time for the ion gate (typically, ion gates have a dead time during which no ions or a reduced amount of ions are transmitted—see, for example, U.S. Pat. No. 7,638,736).
6. Checking the transfer time of ions between various ion optical elements of the instrument.
   This test scans a waiting time between (i) the opening of two ion gates (such as, for example, the ion funnel 22 and the ion gate located in the charge detector assembly 27), or (ii) the opening of one ion gate and the start time of ion detection, or (iii) the pulsing of a voltage applied to an ion optical element and the opening of an ion gate, or (iv) the pulsing of a voltage applied to an ion optical element and the start time of ion detection (e.g. the duration of C-Trap 30a “squeezing”), and monitors the signal intensity. The test then compares the so-produced curve against a reference curve. The reference curve for the reference ion (or for an ion of similar m/z and similar charge state) may be recorded beforehand, e.g. during the full system calibration, or may be the result of data averaged across a multitude of similar calibrated instruments.
   In addition to transfer times, similar test(s) may also check ion thermalisation times (e.g. C-Trap squeezing), and/or may check the time it takes for a voltage regulator to reach its target voltage (e.g. by scanning a pre-inject delay time to see how quickly the ion funnel 22 and C-Trap 30a RF amplitudes are appropriately set).
7. Checking the DC-voltage tuning of the mass analyser.
   This test scans one or more of the DC voltages applied to the mass analyser 40 over a certain range of values and monitors the measured signal intensity for each voltage value. For example, in the case of an Orbitrap™ mass analyser, the test may scan the deflector voltage, and/or the HV offset voltage. The signal intensity may be defined as the total signal or the signal for one or more individual ion species. The test then compares the so-produced curve against a reference curve. The reference curve for the reference ion (or an ion of similar m/z and similar charge state) may be recorded beforehand, e.g. during the full system calibration, or may be the result of data averaged across a multitude of similar calibrated instruments.
   In addition to or instead of DC tunings, timings can also be checked. For example, in the case of an Orbitrap™ mass analyser, the time between the start of the central electrode 41 voltage ramp and the ejection of ions from the C-Trap 30a can be checked.
   In addition to or instead of signal intensity, other observables can be measured as a function of the voltage or timing, such as, e.g., peak width, transient decay time, and/or the ratio between the monoisotopic peak of the reference molecule and one of its isotopes. These are meaningful performance criteria of mass analysers and may change over time, e.g. as the electronics age or as repeated heating and cooling cycles of the analyser lead to mechanical changes.
8. Checking the vacuum pressure inside the mass analyser.
   In the case of an Orbitrap™ mass analyser, this test may measure the transient decay and/or peak width of the reference peak, e.g. using a high-resolution setting, and compare it to a reference value. If the vacuum (e.g. UHV) pressure is too high, significant broadening of the ion peak and/or increase in the signal decay rate is expected (see, for example, U.S. Pat. No. 9,460,905).
9. Checking the overall transmission of the reference ions.
This test may measure the ion intensity (or current), and/or may check the injection time required to reach a certain number of ions or a certain signal-to-noise, and then may compare that value to a reference value.
10. Checking for instabilities and/or drifts in signal intensity which could indicate charge build-up caused by contamination of an ion optical element.
   Contamination of ion optical elements is usually in the form of a build-up of semi-or non-conducting layers on the element's metallic surface. This causes the efficiency of ion transmission to change over time as more ions impinge on the element's surface and charge is built up.
   This test may first attempt to electrically charge or discharge an ion optical element by transmitting ions of one polarity (usually opposite to the polarity used previously) to the element while applying voltages to all subsequent ion optical elements suitable to transmit ions of the opposite polarity. The voltage applied to the ion optical element in question may be such that transmitted ions are attracted towards it to accelerate the charging/discharging process. The test may then switch the voltages to transmit ions and detect ions of the second polarity while observing the signal intensity.
   For example, this test may first attempt to electrically discharge an ion optical device in negative mode, i.e. by producing a high current of negatively charged reference ions, applying a positive DC voltage to the element in question to attract negative ions to the ion optical element, and maintaining subsequent elements with a positive-mode setting (i.e. so that ions cannot reach the subsequent ion optical elements). The instrument may then be switched to positive mode and the ion current may be monitored over time in the positive-mode. Significant charge build-up on the ion optical element in question, which would be characteristic of contamination, would change the electric field and thus impact ion transmission during this time.
   This test benefits from an intense and stable ion signal that can lead to sufficient charging and produces a steady ion flux against which any change in transmission caused by charge-up of an ion optical element can be discerned.
11. Checking the mass accuracy of the reference ions.
   This test may measure the mass accuracy of the reference ions and compare this to a specification limit. The mass accuracy can optionally be re-calibrated (e.g. as described in UK U.S. Pat. No. 2,608,134) based on the reference signal.
12. Checking the state of the solvent delivery line for leaks and/or clogging by monitoring the ion signal of the refence ions or of ions derived from the reference ions and/or the spray current generated by the ion source at one or more solvent flow rates.
   This may be done by monitoring the ion signal of the refence ions or of ions derived from the reference ions over time and determining a measure of fluctuation of the signal intensity, e.g. the standard deviation, for each of one or more solvent flow rates. Operational parameters of the ion source, such as gas flow and gas temperature, may be adjusted to minimize the fluctuation of the signal intensity for a given solvent flow rate.

To perform a check or checks by only measuring a single ion species, the tuning and/or response curves for the reference ion (or for an ion of similar m/z and similar charge state) can be recorded as a reference, e.g. during the full system calibration. The measured reference signal response can then be compared against such reference curve(s) during the health check.

Alternatively, the expected instrument response may be determined from theoretical considerations or from measurements of the reference across multiple instruments, so that the reference curves do not have to be adjusted during a full system calibration. For example, the UHV pressure inside the Orbitrap™ mass analyser, an important factor for the quality of high-resolution spectra, can be estimated from a measurement of the transient decay of the reference ion, and is proportional to the time constant of the exponential decay of the ion signal (see, e.g., UK Patent No. 2525194). The proportionality constant, being dependent on the compound specific collisional cross section, should be known from reference measurements performed using the instrument or the instrument class beforehand. The delivery of a known compound or compound class, ideally the same compound in between instruments, significantly improves the accuracy of the UHV pressure determination.

Overall intensity as well as intensity drifts, e.g. when switching from one ion polarity to the other, can be checked against a fixed specification limit. Mass accuracy can be checked by interpolation and so does not require a direct reference.

It is beneficial that the reference peak appears in the 150-250 m/z range because this allows scanning of the RF voltages widely enough to determine both the low-mass and high-mass cutoffs of transmission through quadrupole devices. Ideally, the low-mass cutoff for the reference ion lies slightly below the maximum RF amplitude of the device in question. Therefore, diagnostics of all RF voltages can be run just with a single peak.

Comparing the reference ion response against a reference curve(s) allows the instrument tuning to be adjusted quickly and easily. In case that the health check shows that certain performance criteria have deteriorated (e.g. due to contamination of the ion optics, due to aging of the electronics, or because ambient conditions such as temperature have changed, etc.), the performance can be restored by adjusting the instrument tuning according to the shift between the optima in the reference and reference curves.

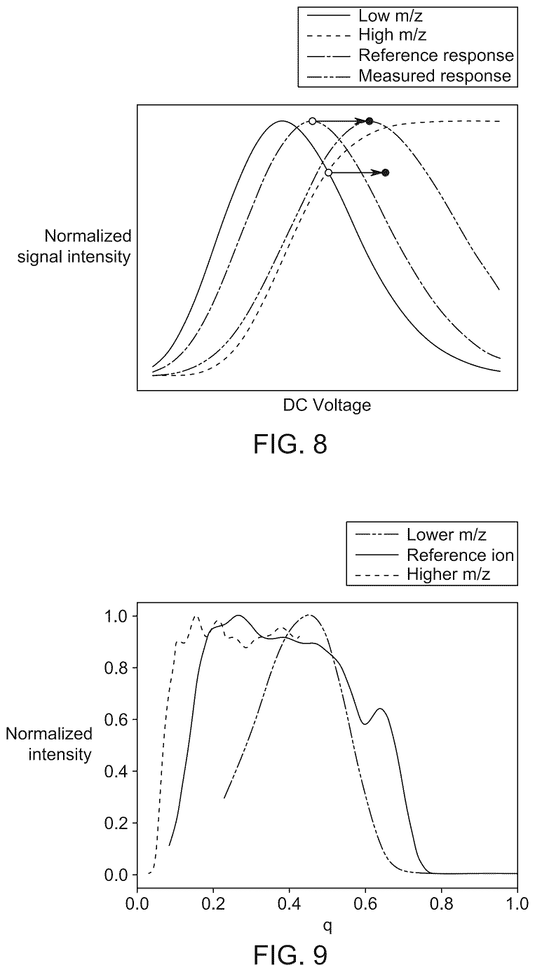

An example of such a process is shown in FIG. 8. FIG. 8 is a simplified sketch showing normalised signal intensity response curves measured as a result of scanning an operational parameter of the system. The response curve may be measured for the reference ion(s) during the method and compared to a reference response curve measured previously for the same reference ion(s). Both of the two curves curve may show one or more optima, wherein the one or more optima of the measured response curve are shifted with respect to the reference response curve (upper arrow). Operating conditions may be found acceptable if the shift is within an expected range.

FIG. 8 also shows how the operational parameter can be quickly and easily adjusted as a result of the check. Full instrument calibration may be performed using different reference ions, e.g. from FlexMix™ calibrant solution, but the difference between the optimal calibration point and the optimum of the reference response curve is known (horizontal shift between the hollow dots). Thus, the new calibration point may be determined as the previous calibration point plus the shift between the optima of the measured and the reference response curves.

FIG. 9 shows measured RF transmission profiles for a reference ion species and for one ion species each with lower and higher m/z (check no. 3). Due to the reference ion's intermediate m/z, its transmission profile shows both the rising and the falling edge of the ion transmission, making it ideally suited to check for changes in instrument performance and/or tuning.

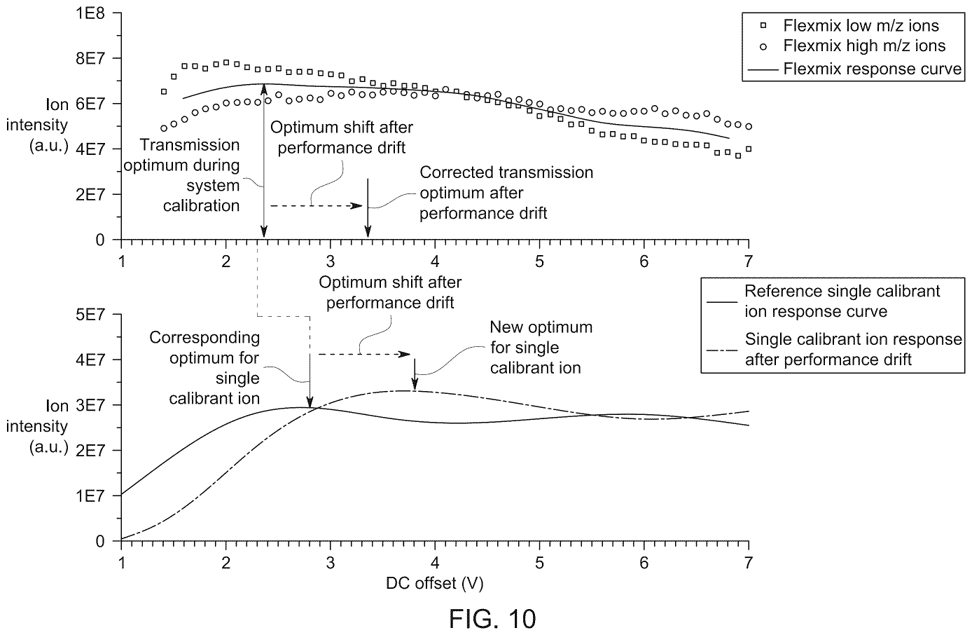

FIG. 10 illustrates the use of reference ions to determine a correction for a DC offset voltage applied to a linear ion trap. The upper panel shows the results of tuning a DC offset voltage for a linear ion guide during system calibration using two ion populations of FlexMix™ ions. The optimum DC offset voltage was determined to be 2.3 V. The lower panel in FIG. 10 shows a recorded reference response curve, as determined using protonated Indole-3-propionic acid (m/z 190.085). After the initial calibration, the instrument settings deteriorated during use, and another response curve of protonated Indole-3-propionic acid was obtained. The change in the DC offset voltage was then determined from the differences (relative change) between the reference response curve and the reference ion response curve.

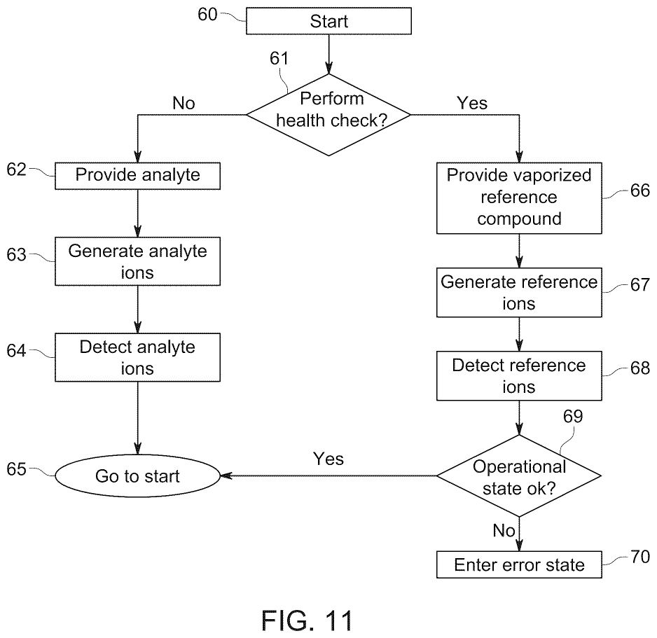

FIG. 11 is a flow diagram illustrating a method of operating an analytical instrument in accordance with embodiments. As illustrated in FIG. 11, at the start of the process (step 60), it is determined whether a health check should be performed (step 61). When no health check is needed (i.e. during an analyte measurement), an analyte is provided (step 62) to the ion source 10 (e.g. via the LC system), the ion source 10 generates analyte ions from the analyte (step 63), and these analyte ions are detected by the instrument (step 64). This process is performed repeatedly by the process then returning to the start (step 65).

When, at step 61, it is determined that a health check is needed, then the vaporised reference compound is provided (step 66) to the ion source 10 (in the manner discussed above), the ion source 10 generates reference ions from the compound (step 67), and these reference ions are detected by the instrument (step 68). The instrument then determines whether or not it is in a correct operational state based on the detection of the reference ions (step 69). When it is determined that the instrument is in a correct operational state, the process returns to the start (step 65). However, when it is determined that the instrument is not in a correct operational state, the instrument can enter an error state (step 70), and corrective action may be taken by the instrument or suggested to the user.

It will be appreciated that embodiments provide a simple and user-friendly instrument health check. The health check can be performed automatically by the instrument, without user interaction such as reconfiguration of the ionisation source. This type of instrument health check is particularly beneficial for routine LC-MS analysis, a field in which manual user intervention such as the reconfiguration of the ionisation source is undesirable.

The health check may use only a single ion species, meaning that a single reference compound can be used. The single point mass calibration can be performed in both positive and negative ion polarity modes. The single point mass calibration enables highly accurate mass analysis for the entire mass range of interest over extended periods of time, particularly for Orbitrap™ mass analysers. For example, embodiments may make it possible to monitor the instrument health for several months, and to adjust instrument tunings on the fly to extend the validity period of a full system calibration.

When the mass spectrometer is coupled to a liquid chromatography system configured to perform a sequence of LC-runs, the secondary ionisation of the volatile neutral compound can be performed at the beginning, at the end, or during one or more LC-runs without reconfiguration of the ionisation source. Periods of low ion current in the m/z range of the reference are commonly observed at the start and end of an LC run, so the reference ion can be readily observed at these times. Additionally or alternatively, a constant low flux of reference vapor can be supplied such that reference ions are frequently observed and available for mass correction throughout an LC-run.

In embodiments, the flow rate and/or solvent composition of the liquid flow supplied to the ion source 10 prior to and/or during the health check may be adjusted, e.g. so as to improve the signal quality during the health check. The flow rate and/or solvent composition may be controlled so that the flow rate and/or solvent composition of the liquid flow during the health check is different to a flow rate and/or solvent composition of the liquid flow during regular analyte measurements. So, the health check can involve initially setting a suitable flow rate and/or solvent composition of the liquid flow supplied to the ion source 10, and then generating reference ions, e.g. without interrupting the liquid flow to the ion source 10. The flow rate and/or solvent composition rate may be set to a value suitable for the check in question, e.g. to ensure a sufficient and stable ion intensity. When the check is complete, the flow rate and/or solvent composition is returned to a value suitable for the subsequent analytical measurement.

In some embodiments, the health check may make use of fragment or adduct ions generated from the parent reference compound ions. In this way, a wider m/z range, the dynamic range of the detector, and potential interactions between ion populations (e.g. space charge effects) can be tested. Fragment and/or adduct populations may be regulated via the vaporiser or ion inlet temperatures, ESI spray settings such as gas flow and spray voltage, in-source CID, or CID in a dedicated collision cell.

Embodiments provide various advantages, including:
The reference ions are generated in the ion source from the primary ions, reflecting the instrument health of all key components, including the ion source.
Embodiments are low-cost as they do not require a separate ion source or other complex components.
The sublimation of the reference compound can be well controlled via the oven temperature and carrier gas flow, thus reference signal delivery is robust over time.
Sublimation of a solid reference is a long-lasting process (if sufficient volume of reference is provided), and so does not require user maintenance (e.g. besides preventive maintenance).
The source of reference gas is a solid, not oxidizable compound, making the reference stable over time.
The reference compound is not toxic, hazardous, carcinogenic, nor environmentally dangerous.
The reference is cheap and readily available.
Secondary ionisation of the reference vapour occurs in both ion source polarities.
Secondary ionisation of the reference vapour can occur for any common type of LC solvent.
The secondary ionisation reaction of the reference vapour is primarily driven by the primary ions of the LC solvent molecules, thus not reducing the concentration of analyte ions.

Although the present invention has been described with reference to various embodiments, it will be understood that various changes may be made without departing from the scope of the invention as set out in the accompanying claims.

What is claimed is:

1. A method of operating an analytical instrument that comprises an analyser and an atmospheric pressure ion source configured to generate analyte ions in an ionisation region, the method comprising:
checking an operational state of the analytical instrument by:
(i) generating reference ions by introducing vaporised molecules or molecule clusters of a reference compound into the ionisation region such that at least some of the vaporised reference compound molecules or molecule clusters are ionised in the ionisation region by the atmospheric pressure ion source;
(ii) detecting, using the analyser, at least some of the reference ions and/or ions derived from the reference ions; and
(iii) determining an operational state of the analytical instrument based on the detection.

2. The method of claim 1, wherein the method further comprises:
performing a plurality of analyte measurements, wherein each analyte measurement comprises: supplying an analyte to the ion source and generating analyte ions; and detecting, using the analyser, at least some of the analyte ions and/or ions derived from the analyte ions;
wherein the step of checking the operational state of the analytical instrument is performed automatically by the instrument between analyte measurements without manual user interaction.

3. The method of claim 1, wherein the ion source is configured to generate analyte ions from a liquid flow, and the method further comprises controlling a flow rate and/or solvent composition of the liquid flow during the step of checking the operational state of the analytical instrument.

4. The method of claim 1, wherein:
the ion source is coupled to a chromatographic separator;
the chromatographic separator is configured to perform a sequence of chromatographic separation runs; and
the step of checking of the operational state of the analytical instrument is performed at the beginning and/or end of and/or during a or each chromatographic separation run.

5. The method of claim 1, wherein the instrument further comprises:
a volume housing a reference compound;
a heater configured to heat the reference compound;
a transfer line connecting the volume to the ionisation region; and
a carrier gas source configured to supply a carrier gas;
wherein the step of (i) generating reference ions comprises:
the heater heating the reference compound such that vaporised molecules and/or molecule clusters of the reference compound are produced in the volume;
the carrier gas source supplying a carrier gas such that at least some of the vaporised reference compound molecules and/or molecule clusters are transported from the volume to the ionisation region via the transfer line; and
at least some of the vaporised reference compound molecules and/or molecule clusters being ionised in the ionisation region so as to generate reference ions.

6. The method of claim 1, wherein the ion source is configured to ionise the vaporised reference compound molecules and/or molecule clusters by gas-phase interactions between: (i) the vaporised reference compound molecules and/or molecule clusters; and (ii) ions and/or charged particles created by the ion source.

7. The method of claim 1, wherein the ion source is configured to generate ions by soft ionisation at atmospheric pressure such as by electrospray ionisation (ESI).

8. The method of claim 1, wherein the step of (ii) detecting comprises: detecting, using the analyser, a single ion species of the reference ions or ions derived from a single ion species of the reference ions.

9. The method of claim 8, wherein the single ion species has a mass to charge ratio (m/z) between 150 Th and 250 Th.

10. The method of claim 1, wherein the step of (iii) determining comprises:
determining that the analytical instrument is in an acceptable operational state based on the detection; or
determining that the analytical instrument is in an unacceptable operational state based on the detection;
wherein the method further comprises:
adjusting one or more operational parameters of the analytical instrument for subsequent operation when it is determined that the analytical instrument is in an unacceptable operational state; and/or
entering an error state when it is determined that the analytical instrument is in an unacceptable operational state; and/or
recalibrating the instrument when it is determined that the analytical instrument is in an unacceptable operational state.

11. The method of claim 1, wherein:
the step of (ii) detecting comprises: detecting the reference ion(s) or the ion(s) derived from the reference ion(s) multiple times during a time period to produce a measured response; and
the step of (iii) determining comprises:
comparing the measured response to an expected response; and
determining that the analytical instrument is in an acceptable operational state when the measured response is the same as or sufficiently similar to the expected response; and/or
determining that the analytical instrument is in an unacceptable operational state when the measured response is different from or insufficiently similar to the expected response.

12. The method of claim 11, wherein the step of (iii) determining comprises:
determining that the ion source is in an acceptable operational state when the measured response is stable or changes by less than a threshold amount during the time period; and/or
determining that the ion source is in an unacceptable operational state when the measured response is unstable or changes by greater than a threshold amount during the time period.

13. The method of claim 11, wherein:
the step of checking the operational state of the analytical instrument comprises charging up a surface of an ion optical element by directing ion current to the surface; and
the step of (iii) determining comprises:
determining that the ion optical element is in an acceptable operational state when the measured response is indicative of an expected discharge rate during the time period; and/or
determining that the ion optical element is in an unacceptable operational state when the measured response is indicative of an unexpected discharge rate during the time period.

14. The method of claim 11, wherein the step of detecting comprises: measuring an intensity of the reference ion(s) or the ion(s) derived from the reference ion(s) multiple times during the time period to produce a measured intensity response, wherein the expected response is an expected intensity response.

15. The method of claim 1, wherein:
the step of (ii) detecting comprises: measuring a property of the reference ion(s) or the ion(s) derived from the reference ion(s); and
the step of (iii) determining comprises:
comparing the measured value of the property to an expected value of the property; and
determining that the analytical instrument is in an acceptable operational state when the measured value of the property is equal to or differs by less than a threshold from the expected value of the property; and/or
determining that the analytical instrument is in an unacceptable operational state when the measured value of the property is unequal to or differs by greater than a threshold from the expected value of the property.

16. The method of claim 15, wherein the step of (iii) determining comprises:
determining that a pressure within the analyser is at an acceptable level when the measured value of the property is equal to or differs by less than the threshold from the expected value of the property; and/or
determining that the pressure within the analyser is at an unacceptable level when the measured value of the property is unequal to or differs by greater than a threshold from the expected value of the property.

17. The method of claim 15, wherein the property is or is indicative of an intensity, intensity decay rate with increasing flight path length, peak width, transient decay rate, or mass to charge ratio (m/z).

18. The method of claim 15, wherein:
the instrument comprises a fragmentation or activation device:
the step of (ii) detecting comprises measuring an intensity ratio between one or more ion(s) derived from the reference ion(s) and one or more reference ion(s); and
the step of (iii) determining comprises:
determining that the fragmentation or activation device is in a correct operational state when the measured intensity ratio is equal to or differs by less than a threshold from an expected value of the intensity ratio; and/or
determining that the fragmentation or activation device is in an incorrect operational state when the measured value of the intensity ratio is unequal to or differs by greater than a threshold from the expected value of the intensity ratio.

19. The method of claim 1, wherein:
the step of (ii) detecting comprises: detecting the reference ion(s) or the ion(s) derived from the reference ion(s) multiple times during a time period to produce a measured response;
the method further comprises varying an operational parameter of the analytical instrument over a range during the time period such that the measured response is a response of the detected ion(s) to the variation of the operational parameter over the range; and
the expected response is a reference response of the detected ion(s) to the variation of the operational parameter over the range.

20. The method of claim 19, wherein the reference response is interpolated from a response of one or more different ions to the variation of the operational parameter over the range.

21. The method of claim 19, wherein the method further comprises:
determining, from the measured response, an improved or optimum value of the operational parameter; and
setting the operational parameter to correspond with the improved or optimum value during subsequent operation of the analytical instrument.

22. The method of claim 19, wherein the operational parameter is the value of or a difference between two or more values of: a DC voltage magnitude, an RF voltage amplitude, an RF voltage frequency, a pressure, a time, a time period, a temperature, and/or a flow rate.

23. An analytical instrument comprising a control system, the control system configured to cause the analytical instrument to perform the method of claim 1.
